(19) United States
(12) Patent Application Publication
(10) Pub. No.: US 2009/0070962 A1
(43) Pub. Date: Mar. 19, 2009

(54) Open-slot hinge fixing assembly

(75) Inventor: Ding-Hone Su, Taipei County (TW)

Correspondence Address: Joe McKinney Muncy, PO Box 1364, Fairfax, VA, 22038-1364, US

(73) Assignee: Sinher Technology Inc.

(21) Appl. No.: 11/898,611

(22) Filed: Sep. 13, 2007

(51) Int. Cl. E05D 3/02

(52) U.S. Cl. 16/360

(57) ABSTRACT

The present invention discloses an open-slot hinge fixing assembly such as a hinge particularly installed at a position of connecting a main system and a display device that includes an axle sleeve support stand, an axle sleeve and an axle. The axle sleeve has a connecting portion, and the axle is installed axially into the axle sleeve, and the axle sleeve support stand has a containing groove for accommodating the axle sleeve, and the containing groove includes an insert slot for inserting the connecting portion, and both ends of the containing groove have corresponding support holes for axially connecting the axle, and the axle sleeve has an actuator opening and an axial connecting channel, and the axle has an axial connecting portion axially connected to the axial connecting channel.

### FIELD OF THE INVENTION

The present invention relates to a hinge, and more particularly to a hinge applied to a position of connecting a main system and a display device, and the display device can be spread open with respect to the main system and positioned at different angles by its friction.

### BACKGROUND OF THE INVENTION

As science and technology develop rapidly, many technological products come with a display function, and thus liquid crystal display device becomes a mainstream display of high-tech products. Regardless of personal computers, notebook computers or mobile phone required by most people, these products need a display device. For the liquid crystal display devices placed on a desk top, it is one of the important functions to provide an adjustment of the angle of an LCD panel. Not only a desktop computer needs to adjust the angle of its LCD panel according to users' requirements, but the display device of a notebook computer also requires such angle adjusting function. Of course, this function is equally important for mobile phones, and we definitely need a structural design to achieve the best angle adjusting function for liquid crystal display devices, and two prior arts are given as examples and reference.

In the conventional patent of R.O.C. Pat. Publication No. M315362, an axle stabilizing structure of a single-head axle sleeve is disclosed. Referring to FIGS. 1 and 2 of R.O.C. Pat. Publication No. M315362 for a perspective view and an exploded view of a prior art axle stabilizing structure respectively, the axle stabilizing structure of a single-head axle sleeve is applied at a position of connecting a main system and a display device (not shown in the figure), and a display device can be spread open with respect to the main system and positioned at different angles by its friction. The axle 1 comprises a single-head axle sleeve 10, an axial shaft 20 and an axle sleeve cover 30; wherein the single-head axle sleeve 10 has a latch portion 11 and a turning portion 12 extended from the latch portion 11; an end of the axial shaft 20 has an axial connecting portion 21 pivotally coupled to the latch portion 11, and another end has a fixing portion 22 fixed to the main system; and the axle sleeve cover 30 is used for covering the single-head axle sleeve 10 and has an extending portion 32. The extending portion 32 has a connecting hole 321 for connecting the display device, and the connecting hole 321 can be fixed to the display device by a screw or a rivet (not shown in the figure). In addition, the axle sleeve cover 30 includes a containing groove 31 having a shape matched with the single-head axle sleeve 10, such that the single-head axle sleeve 10 can be accommodated completely inside the axle sleeve cover 30. The latch portion 11 has an axial connecting area 111, and a friction is produced between the axial connecting area 111 and the axial connecting portion 21 of the axial shaft 20, so that the display device can be positioned at different angles when the display device is spread open or shut with respect to the main system (not shown in the figure). Since the latch portion 11 has an actuation engaging opening 112, therefore the friction between the axial shaft 20 and the axial connecting portion 21 will enlarge the actuation engaging opening 112 when the display device is turned and spread open with respect to the main system. In other words, the actuation engaging opening 112 will become larger than its normal size, and the required applying force will become smaller. If the display device is turned in an opposite direction to shut with respect to the main system, the friction contracts the actuation engaging opening 112. In other words, the actuation engaging opening 112 will become smaller than its normal size, and the required applying force will become larger to cover the display device onto the main system.

Referring to FIGS. 3 to 5 of R.O.C. Pat. Publication No. M315362 for a prior art axle stabilizing structure of a single-head axle sleeve and FIGS. 1 to 3 of R.O.C. Pat. Publication No. M315362 for schematic views of configurations of a prior art fixing member of the aforementioned patent respectively, the conventional axle stabilized structure of a single-head axle sleeve comprises a fixing portion 22 of the axial shaft 20 fixed to fixing members 40, 50, 60 respectively, and the fixing members 40, 50, 60 are fixed to the main system (not shown in the figure), so that a friction is produced between the axial connecting area 111 of the single-head axle sleeve 10 and the axial connecting portion 21 of the axial shaft 20.

Referring to FIGS. 1 to 4 of R.O.C. Pat. Publication No. M315363 for an exploded view, a perspective view and planar views of a prior art axle sleeve joint structure, the axle 1 comprises an axle sleeve 10, an axial shaft 20, an axle sleeve cover 30 and a coupling means 33, 33′, wherein the axle sleeve 10 has a latch portion 11 and a turning portion 12 extended from the latch portion 11, and the turning portion 12 has a coupling hole 13, and an end of the axial shaft 20 has an axial connecting portion 21 pivotally coupled with the latch portion 11, and another end has a fixing portion 22 fixed to the main system. The axle sleeve cover 30 is provided for covering the axle sleeve 10, and includes an extending portion 32, and the extending portion 32 has a connecting hole 321 for fixing the display device, and the connecting hole 321 can be fixed with the display device by a screw or a rivet (not shown in the figure). In addition, the axle sleeve cover 30 includes a containing groove 31 having a shape matched with the axle sleeve 10, such that the axle sleeve 10 can be accommodated into the axle sleeve cover 30 completely, and the axle sleeve cover 30 has a coupling hole 322 for passing the containing groove 31; and the coupling means 33, 33′ can be a screw or a rivet passing through a coupling hole 322 of the axle sleeve cover 30 and fixed by the coupling hole 13 of the axle sleeve 10, and the axle sleeve 10 is fixed into the containing groove 31 of the axle sleeve cover 30, and the latch portion 11 has an axial connecting area 111. A friction is produced between the axial connecting area 111 and the axial connecting portion 21 of the axial shaft 20. The latch portion 11 has an actuation engaging opening 112, so that when the display device is turned to be spread open with respect to the main system, the friction at the axial connecting portion 21 of the axial shaft 20 enlarges the actuation engaging opening 112. In other words, the actuation engaging opening 112 will become larger than its normal size, and the required applying force will become smaller. If the display device is turned in an opposite direction to shut the display device with respect to the main system, the friction will contract the actuation engaging opening 112. In other words, the actuation engaging opening 112 will become smaller than its normal size, and a larger force will be required to cover the display device back onto the main system.

Referring to FIGS. 5 to 7 of R.O.C. Pat. Publication No. M315363 for schematic views of an axle sleeve joint structure and a fixing member in accordance with first, second and third configurations of a prior art respectively, the fixing portion 22 of the axial shaft 20 is fixed to a fixing member 40, 50, 60, and the fixing member 40, 50, 60 is fixed to the main system (not shown in the figure), so that a friction is produced between the axial connecting area 111 of the axle sleeve 10 and the axial connecting portion 21 of the axial shaft 20.

The aforementioned two prior arts have the following drawbacks:

1. Shaking: When the axle sleeve is installed, the space of the containing groove must be larger than the axle sleeve, but it is not easy to make a containing groove in compliance with the size of the axle sleeve. Therefore, shaking occurs easily after a force is applied.

2. Pseudo Torque: Since the containing groove cannot be made in compliance with size of the axle sleeve easily, therefore a too-tight connection of the containing groove of the axle sleeve will produce a too-large torque when a force is applied to the axle.

3. Falling Out: The axle sleeve in accordance with the first aforementioned prior art cannot be secured onto the axle sleeve cover, and thus they may fall out easily when an angle is adjusted. The axle sleeve in accordance with the second aforementioned prior art uses fixes the axle sleeve cover by screws, and thus the axle may fall out easily from the axle sleeve.

4. Interference: Regardless of a too-loose or too-tight status of the containing groove, the torque of the assembly will be affected.

In view of the foregoing four drawbacks of the prior art, the inventor of the invention provides a solution to overcome the foregoing drawbacks and achieve a complete assembly that will not be shaking, producing a pseudo torque, falling out or interfered.

### SUMMARY OF THE INVENTION

It is the primary objective of the invention to provide a stable assembly, such that the friction between an axle and an axle sleeve will not be affected by other factors in order to produce a normal torque.

To achieve the foregoing objective, the present invention provides a technical solution for an open-slot hinge fixing assembly, and the assembly comprises an axle sleeve support stand, an axle sleeve and an axle, wherein the axle sleeve has a connecting portion, and the axle is axially installed into the axle sleeve, and the axle sleeve support stand has a containing groove for accommodating the axle sleeve, and the containing groove contains an insert slot for inserting the connecting portion, and both ends of the containing groove are axially coupled to the axle and have corresponding support holes disposed on both ends respectively. The axle sleeve includes an actuator opening and an axial connecting channel, and an end of the axle has an axial connecting portion axially coupled with the axial connecting channel.

Compared with the prior arts, the open-slot hinge fixing assembly of the invention with the aforementioned technical solution has the following advantages:

1. Since the axle sleeve support stand comes with an open-slot design and a containing groove, therefore the axle sleeve is disposed at the containing groove, and both ends of the axle sleeve support stand have a circular support axle each for improving the shaking problem occurred when a hinge is turned, and the open-slot hinge fixing assembly of the present invention is stable.

2. Since the axle is axially installed into the axial connecting channel, and the axle uses the support holes on both ends of the axle sleeve support stand for the support, and the axial connecting channel only provides the axle a function of producing frictions, therefore the open-slot design of the open-slot hinge fixing assembly in accordance with the present invention will not interfere the axle sleeve or produce pseudo torque. Thus, the invention can maximize its normal torque.

The detailed description of preferred embodiments of the invention and their effects are given below.

### BRIEF DESCRIPTION OF THE DRAWINGS

FIG. 1 is an exploded view of an open-slot hinge fixing assembly in accordance with the present invention;

FIG. 2 is a schematic view of an open-slot hinge fixing assembly in accordance with the present invention;

FIG. 3 is a section view of an open-slot hinge fixing assembly in accordance with the present invention;

FIG. 4 is a section view of an axle sleeve support stand of an open-slot hinge fixing assembly in accordance with the present invention;

FIG. 5 is a schematic view of an open-slot hinge fixing assembly in accordance with a preferred embodiment of the present invention; and

FIG. 6 is a schematic view of an open-slot hinge fixing assembly in accordance with another preferred embodiment of the present invention.

### DETAILED DESCRIPTION OF THE PREFERRED EMBODIMENTS

The present invention provides an open-slot hinge fixing assembly 10 installed at a position for connecting a main system and a display device to achieve a stable, an appropriate torque and a uniformly distributed friction, and an embodiment of the open-slot hinge fixing assembly 10 is described as follows:

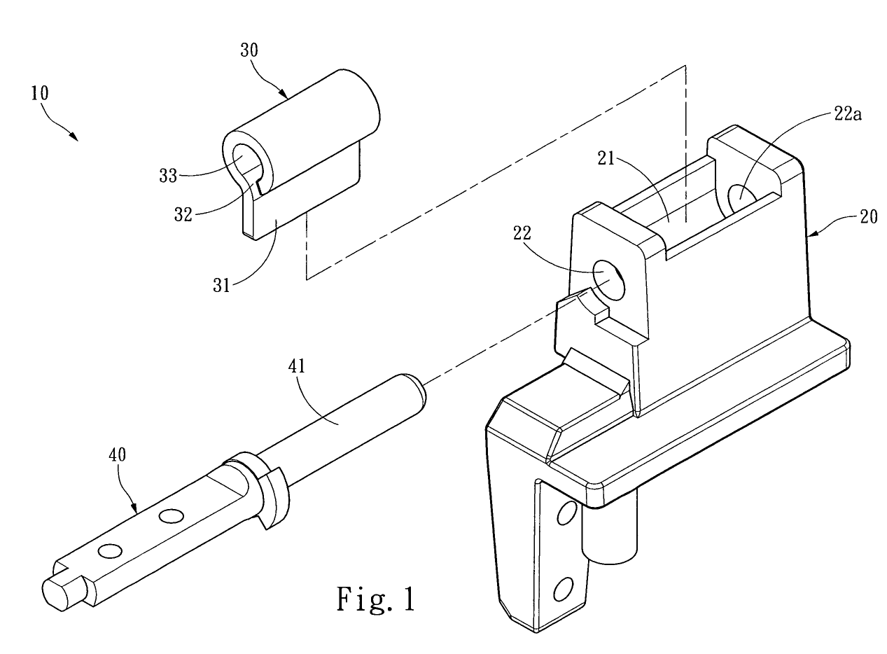

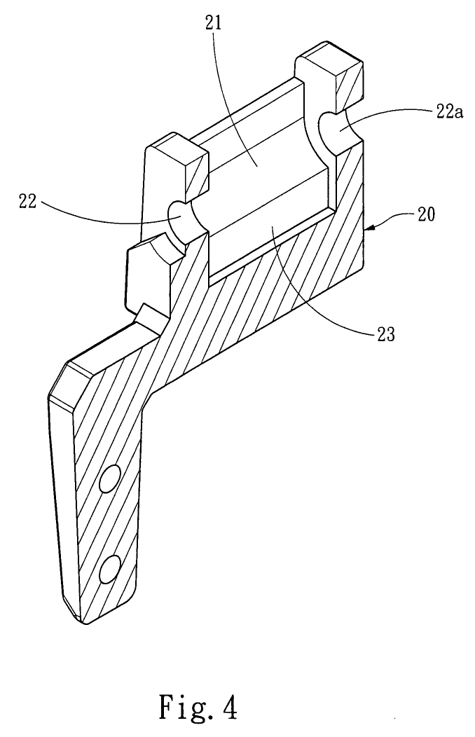

Referring to FIGS. 1 and 4 for an exploded view of an open-slot hinge fixing assembly and a section view of an axle sleeve support stand in accordance with the present invention respectively, the assembly comprises an axle sleeve support stand 20, an axle sleeve 30 and an axle 40, and the axle sleeve 30 has a connecting portion 31 and the axle 40 is installed axially into the axle sleeve 30, and the axle sleeve support stand 20 includes a containing groove 21 for accommodating the axle sleeve 30, and the containing groove 21 includes an insert slot 23 for inserting the connecting portion 31, and both ends of the containing groove 21 have corresponding support holes 22 for axially connecting the axle 40. The axle sleeve 30 is installed into the containing groove 21, such that the connecting portion 31 can be inserted into the insert slot 23, and then the axle 40 is passed from the support hole 22 to another support hole 22a, such that the axial connecting portion 41 can be installed axially into the axial connecting channel 33.

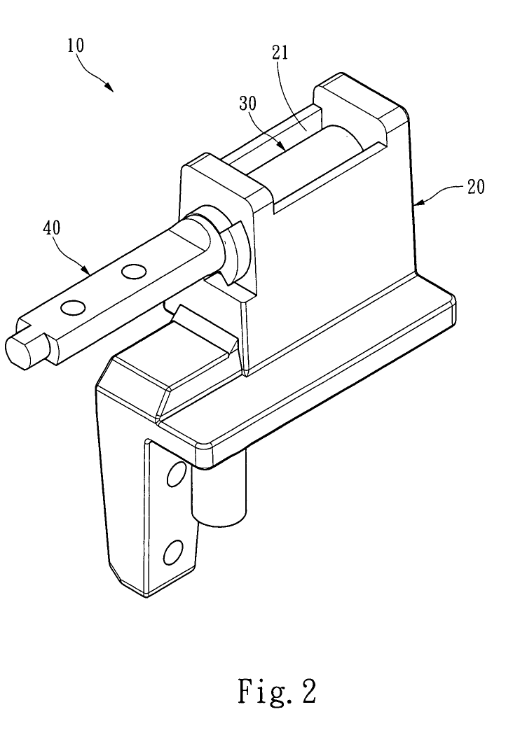

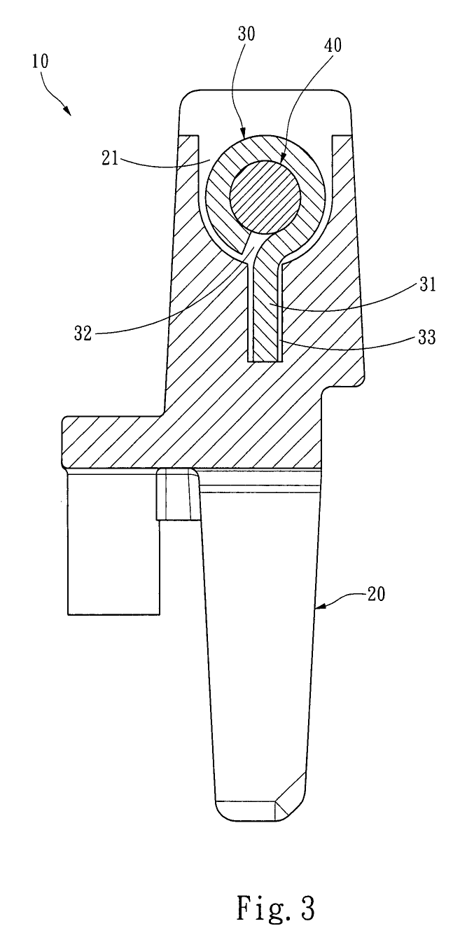

Referring to FIGS. 2 and 3 for a perspective view and a section view of an open-slot hinge fixing assembly in accordance with the present invention respectively, after the aforementioned installation procedure is performed, the axle sleeve 30 is installed into the containing groove 21, and the axle 40 is passed and installed into the support hole 22, 22a and the axial connecting channel 33, and the axial connecting portion 41 and the axial connecting channel 33 are engaged securely with each other. A gap is formed between the axle sleeve 30 and the containing groove 21, and the connecting portion 31 is inserted into the insert slot 23. If a user applies a force at the axle 40, the axial connecting channel 33 and the axle 40 will be engaged or loosened from each other according to the rotation direction of the force applied to the axle 40. The axle sleeve 30 has an actuator opening 32 which is an adjusting space for engaging or loosening the axial connecting channel 33 and the axle 40, and the connecting portion 31 is inserted into the insert slot 23. If the axial connecting channel 33 is secured or loosened, the way of connecting the connecting portion 31 with the insert slot 23 can achieve a stable effect, and the connecting portion 31 and the insert slot 23 can produce an action force to press with each other, so that the axle 40 can be turned smoothly and stably when a force is applied onto the axle 40. With the support holes 22, 22a, both ends of the axle 40 can be supported stably to provide a better balanced friction at the axle 40 in the axial connecting channel 33 and achieve a structure with uniformly distributed frictions.

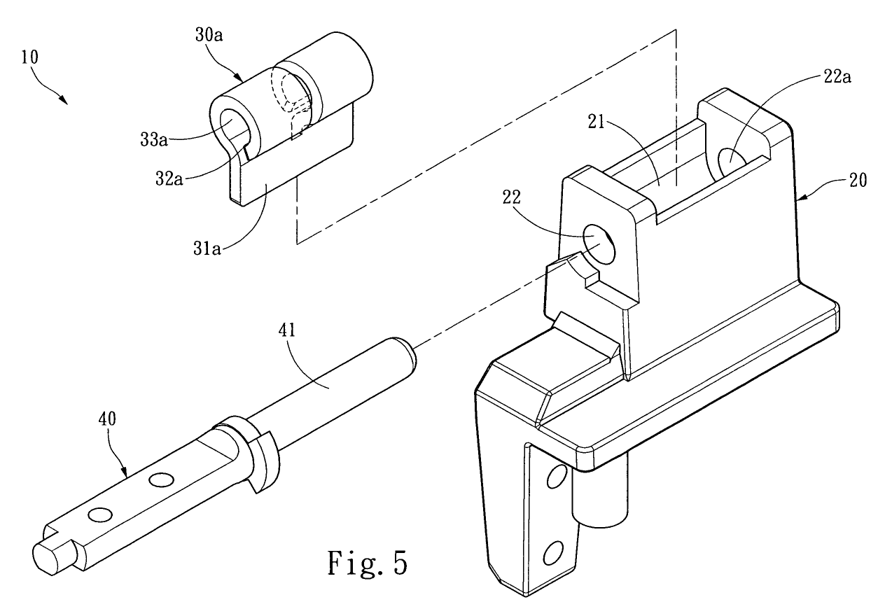

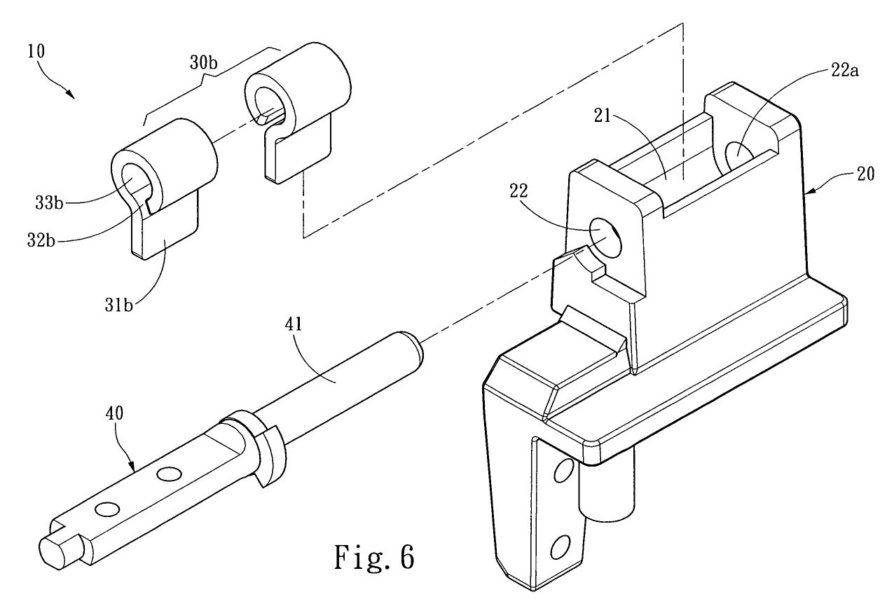

Referring to FIGS. 5 and 6 for schematic views of an open-slot hinge fixing assembly in accordance with preferred embodiments of the present invention, the axle sleeve 30 can be of different structural forms. In FIGS. 5 and 6, the axle sleeve 30 is connected with the axle sleeve support stand 20 and the axle 40 in the same way. In FIG. 5, the axle sleeve 30a is divided into two portions, and the actuator opening 32a is situated at an axle sleeve 30a, each on both sides of the connecting portion 31a, such that the axle 40 is axially connected into the axle sleeve 30a. When the axle 40 is rotated in the axial connecting channel 33a, the friction so produced will be uniform. In FIG. 6, the axle sleeve 30ba is divided into two models in opposite directions. When the axle 40 is rotated, a uniformly distributed friction is produced on both ends of the axle sleeve 30b, and thus both of the aforementioned arrangements can achieve the advantages of the present invention.

While the open-slot hinge fixing assembly 10 of the invention has been described by means of specific embodiments, numerous modifications and variations could be made thereto by those skilled in the art without departing from the scope and spirit of the invention set forth in the claims.

In summation of the description above, the open-slot hinge fixing assembly 10 of the invention adopts an open-slot design of the axle sleeve support stand 20, and thus the shaking, falling out, and interference problems of the prior arts due to the axle sleeve being smaller than the hole of an axle sleeve cover can be solved, and a stable structure can be achieved. In addition, the support holes 22, 22a on both ends of the axle sleeve support stand 20 are provided for supporting the axle 40, and thus an uniform friction between the axle 40 and the axial connecting channel 33 can be achieved to prevent pseudo torques. Obviously, the present invention not only gives a stable assembly, but also provides a uniformly distributed friction between the axle 40 and axial connecting channel 33 to maximize the torque performance. The present invention complies with the requirements for a patent application and is duly filed for patent application.

What is claimed is:

1. An open-slot hinge fixing assembly, installed at a position of connecting a main system and a display device, and the assembly comprising:
an axle;
an axle sleeve, having a connecting portion, for axially installing the axle into the axle sleeve; and
an axle sleeve support stand, having a containing groove for accommodating the axle sleeve support stand, an insert slot disposed in the containing groove for inserting the connecting portion, and corresponding support holes disposed respectively on both ends of the containing groove for axially connecting the axle.

2. The open-slot hinge fixing assembly of claim 1, wherein the axle sleeve has an actuator opening.

3. The open-slot hinge fixing assembly of claim 1, wherein the axle sleeve has an axial connecting channel.

4. The open-slot hinge fixing assembly of claim 3, wherein the axle has an axial connecting portion axially coupled to the axial connecting channel.
